(19) United States
(12) Patent Application Publication
(10) Pub. No.: US 2004/0027619 A1
(43) Pub. Date: Feb. 12, 2004

(54) Information relay terminal and information distribution server

(75) Inventors: Junichi Sato, Tokyo (JP); Tomoaki Ito, Kawasaki-shi (JP); Takao Yamaguchi, Tokyo (JP); Ichiro Takei, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/613,030

(22) Filed: Jul. 7, 2003

(30) Foreign Application Priority Data
Jul. 10, 2002 (JP) 2002-201563
Jun. 12, 2003 (JP) 2003-168426

(51) Int. Cl. H04N 1/00

(52) U.S. Cl. 358/407

(57) ABSTRACT

In the present invention, an information distribution terminal adds an ID of the terminal and ID of a user of the terminal to transmission information to relay and distribute in relying and distributing the transmission information including an electronic coupon, and an information compiling server that finally receives the transmission information refers to IDs of terminals or users of the terminals added successively due to relay, and provides benefits to the users corresponding to the IDS.

### BACKGROUND OF THE INVENTION

1. Field of the Invention

The present invention relates to an information relay terminal that receives information such as advertisements and information distribution server.

2. Description of the Related Art

A business practice has been put into a practical use that increases advertising effectiveness by providing benefits such as discounts to customers who present printed electronic coupons that are acquired on, for example, personal computers using WWW (World Wide Web) on the internet or electronic coupons received on cellular telephones. Such a business practice is disclosed in, for example, Japanese Laid-Open Patent Publication No.2001-195471.

In the example, as a method of distributing electronic coupons, a method is adopted in which an electronic coupon is directly transmitted to a client by e-mail or a client accesses to WWW to acquire an electronic coupon.

However, in the conventional technique as described above, who refer to electronic coupons are persons who are already clients or persons who are interested in the product and/or shop. Therefore, electronic coupons have only a little effect on advertisement propagation.

Meanwhile, it is considered that a person who acquired an electronic coupon relays the coupon to another person to distribute. As methods of relaying and distributing electronic coupons, it is possible to use e-mails or transmit data in short-distance infrared (IR) communications or in wireless communications. Examples of short-distance IR communications include Bluetooth (for example, “Bluetooth Guidebook”, Miyazu, Kazuhiro, Nikkan Kogyo Shibunsha), and using scatter-net (page 85), a multihop transmission method may be used of transmitting data via a plurality of relay terminals.

However, for persons who relay and distribute electronic coupons, there are no merits obtained by relaying and distributing electronic coupons under present conditions, or in some cases, demerits may occur because communications costs are high. Accordingly, since the persons hesitate to relay and distribute electronic coupons, the effect on advertisement propagation is not enhanced.

On the contrary, also in the case where a large number of relay terminals relay and distribute the coupons without limitation, explosive increases in transmission amount cause relay distribution to be clogged and do not enhance the effect on advertisement propagation either.

### SUMMARY OF THE INVENTION

It is an object of the present invention to provide an information distribution server and information relay terminals having a significant effect on information propagation.

To achieve the above object, in the present invention, when information distribution relay terminals relay and distribute transmission information including electronic coupons, the transmission information is provided with IDS of relay terminals and IDs of users of the relay terminals, and an information compiling server that finally receives the transmission information refers to IDS of the relay terminals or the users of the relay terminals added successively due to relay, and provides benefits to the users corresponding to the IDS.

In this way, it is possible to provide benefits to users that relay and distribute the information and users that provide new information. As a result, for the purpose of obtaining the benefits, the users start aggressively relaying and distributing information or providing information, relay distribution or provision of information is thus accelerated, and the effect on information propagation is enhanced.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which:

FIG. 1 is a diagram illustrating an entire configuration of an information distribution system according to a first embodiment of the present invention;

FIG. 2 is a flowchart illustrating a processing flow in relay terminals according to the first embodiment;

FIG. 3 is a diagram illustrating a format of a list of information according to the first embodiment;

FIG. 4 is a diagram illustrating a configuration of an information distribution system according to a second embodiment of the present invention;

FIG. 5 is a diagram illustrating another configuration of an information distribution system according to the second embodiment;

FIG. 6 is a diagram illustrating a configuration of an information distribution system according to a third embodiment of the present invention;

FIG. 7 is a diagram illustrating a configuration of an information distribution system according to a fourth embodiment of the present invention;

FIG. 8 illustrates a flowchart of processing of a relay terminal receiving an unknown ID according to the fourth embodiment;

FIG. 9 illustrates a flowchart of processing in which relay terminals transmit respective specific information of the relay terminals to a server according to the fourth embodiment;

FIG. 10 is a diagram illustrating a configuration of an information distribution system according to a fifth embodiment of the present invention;

FIG. 11 is a diagram illustrating an example of retransmission control according to the fifth embodiment;

FIG. 12 is another diagram illustrating an example of retransmission control according to the fifth embodiment;

FIG. 13 is a diagram illustrating a configuration of a control information transmitting server according to the fifth embodiment;

FIG. 14 is a diagram illustrating a configuration of an information distribution server according to the fifth embodiment;

FIG. 15 is a diagram illustrating a configuration of an information compiling server according to the fifth embodiment;

FIG. 16 is a diagram illustrating information according to the fifth embodiment;

FIG. 17 is a diagram illustrating control information according to the fifth embodiment;

FIG. 18 is a diagram illustrating relay history information according to the fifth embodiment;

FIG. 19 is a diagram illustrating collection information according to the fifth embodiment;

FIG. 20 illustrates a first operation flowchart of a relay terminal receiving the information according to the fifth embodiment; and

FIG. 21 illustrates a second operation flowchart of the relay terminal receiving the information according to the fifth embodiment.

### DETAILED DESCRIPTION OF THE PREFERRED EMBODIMENTS

(First Embodiment)

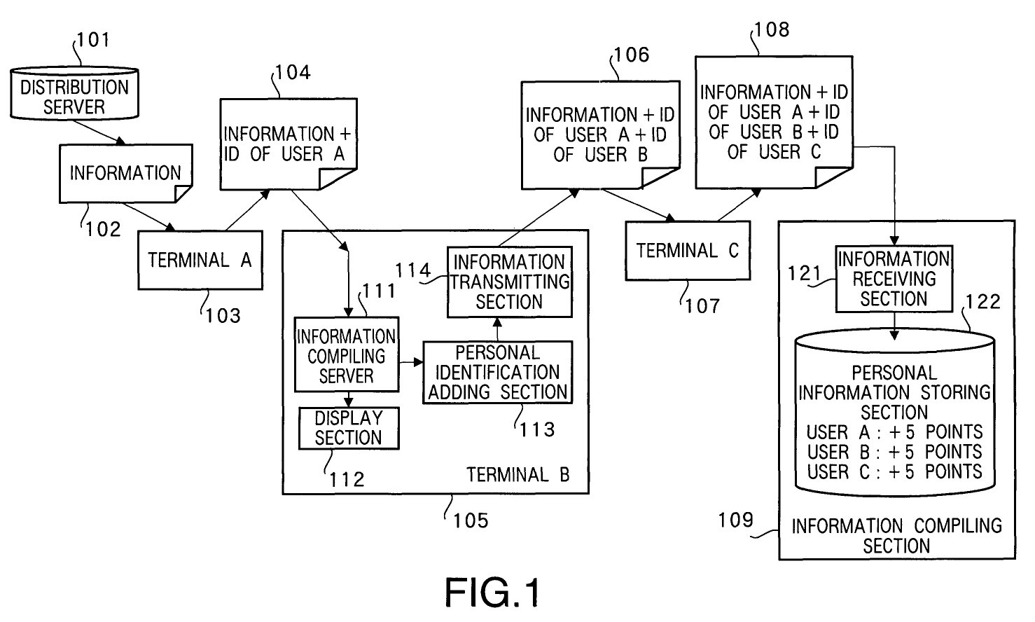

An information distribution system according to the first embodiment of the present invention will be described below. A configuration of the information distribution system according to the first embodiment will be described first with reference to FIG. 1. FIG. 1 is a diagram illustrating the information distribution system according to the first embodiment.

Information distribution server 101 transmits information 102 such as an electronic coupon to other relay terminals. Information distribution server 101 may transmit information to specific information distribution relay terminals (for example, relay terminal A 103) or may broadcast (multicast) information to indefinite information distribution relay terminals.

Relay terminal A 103 receives information 102, and adds an ID that is a personal identification of user A of the relay terminal A 103 to received information 102.

Relay terminal B 105 receives information 104 provided with the ID of user A transmitted from relay terminal A 103. Similarly, relay terminal B 105 adds an ID of user B of relay terminal B 105 to received information 104 with the ID of user A.

The operation as described above is repeated in which a relay terminal adds an ID of a user of the relay terminal to received information to transmit. In FIG. 1, relay terminal C 107 that receives information 106 with IDS of users A and B 106 adds an ID of user C of relay terminal C 107 to information 106 transmit to information compiling server 109.

In addition, information compiling server 109 may be information distribution server 101. Further, information may not be transmitted to information compiling server 109, or an ID for identifying information may be transmitted to the server 109, substituting the information.

In information compiling server 109, information receiving section 121 receives information 108, IDS of users A, B and C are extracted from information 108, and information on the IDS are rewritten and stored in personal information storing section 122.

Referring to FIG. 1, the operation of relay terminals according to the first embodiment will be described below with reference to relay terminal B 105 as an example.

In relay terminal B 105, information receiving section 111 receives information 104, and display section 112 indicates information 104 to user B of relay terminal B 105. Further, in relay terminal B 105, personal identification adding section 113 adds a personal identification of user B to information 104 received in information receiving section 111, and information transmitting section 114 transmits the resultant.

The personal identification is a character sequence (including a sign sequence) enabling information compiling server 109 to specify a relay terminal or user of the relay terminal, and for example, includes a telephone number of a user, serial number of a relay terminal, amember's number of a users of a shop or facility that uses information compiling server 109.

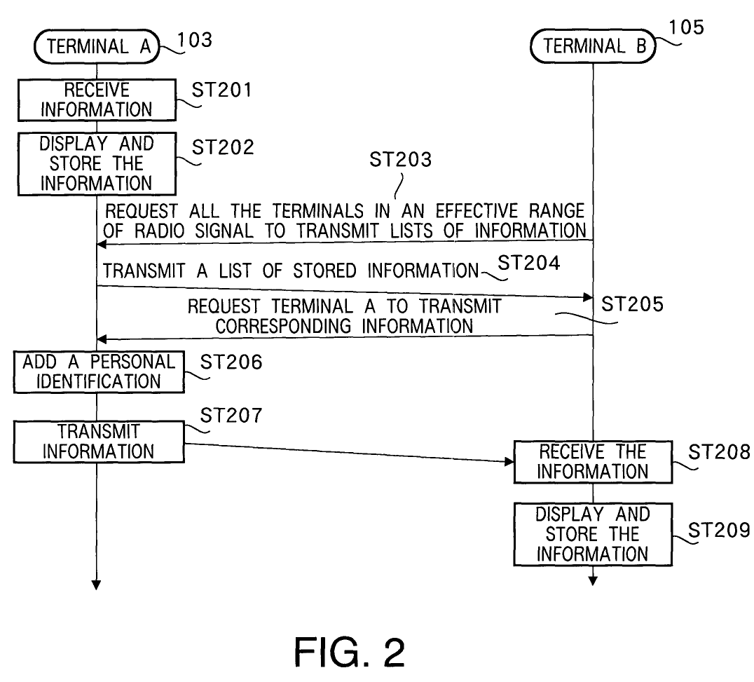

A processing flow in relay terminals A 103 an B 105 is illustrated in FIG. 2. FIG. 2 is a flowchart illustrating the processing flow in relay terminals according to the first embodiment.

Relay terminal A 103 receives information from the information distribution server or another relay terminal (ST201), and displays and stores the received information (ST202).

Meanwhile, in order to receive information from other relay terminals, relay terminal B 105 transmits a request for transmitting a list of information stored in each relay terminal to all the relay terminals existing in an effective range of radio signal using the radio signal (ST203).

As a protocol for use in requesting for transmitting information, for example, HTTP (HyperText Transfer Protocol) is used. HTTP is a transmission protocol standardized in Internet Engineering Task Force. Internet Engineering Task Force is described on a website with “http://www.ietf.org”.

Relay terminal B 105 receives the list of information (ST204), selects required information from the information list, and requests relay terminal A 103 to transmit the selected information (ST205).

In response thereto, relay terminal A 103 adds the personal ID of relay terminal A 103 to the stored information (ST206) to transmit (ST207).

In response thereto, relay terminal B 105 receives the information (ST208), and displays and stores the information (ST209).

Subsequently, relay terminal B 105 is capable of performing the same processing as that in relay terminal A 103. In addition, in the example in FIG. 2, although relay terminal A 103 transmits information in response to a transmission request received from relay terminal B 105, relay terminal A 103 may transmit information to all the relay terminals irrespective of the presence or absence of a transmission request.

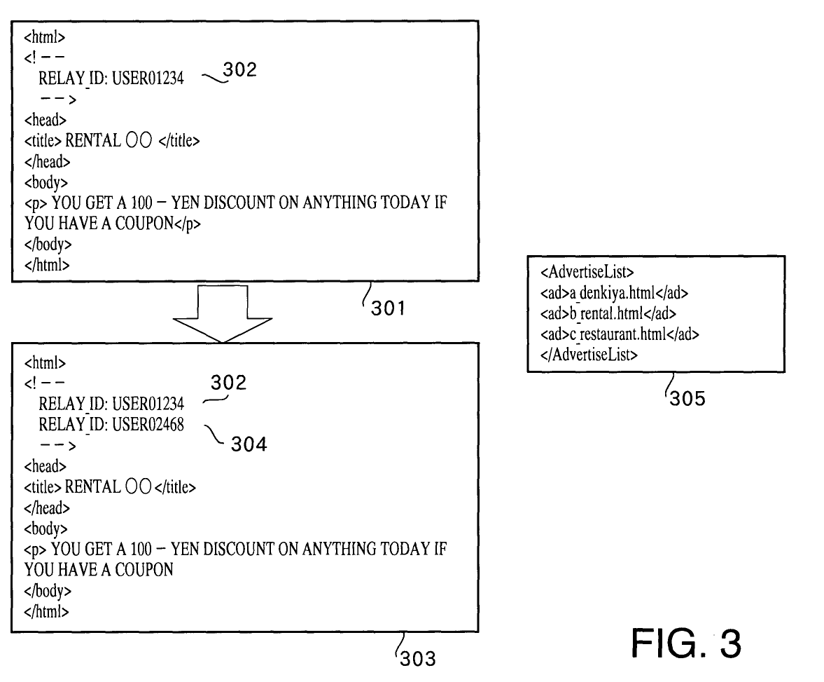

An example of format for describing information is illustrated in FIG. 3. FIG. 3 illustrates the format of information according to the first embodiment.

As a format for describing information, for example, HTML (HyperText Markup Language) is used. HTML is a language standardized in World Wide Web Consortium. World Wide Web Consortium is described on a website with “http://www.w3.org”.

Information 301 received in a relay terminal is described in HTML, and has ID 302 of another relay terminal inserted thereto. The relay terminal reads information 301, inserts ID 304 registered with the relay terminal to a portion to which ID 302 is inserted to obtain information 303, and transmits information 303.

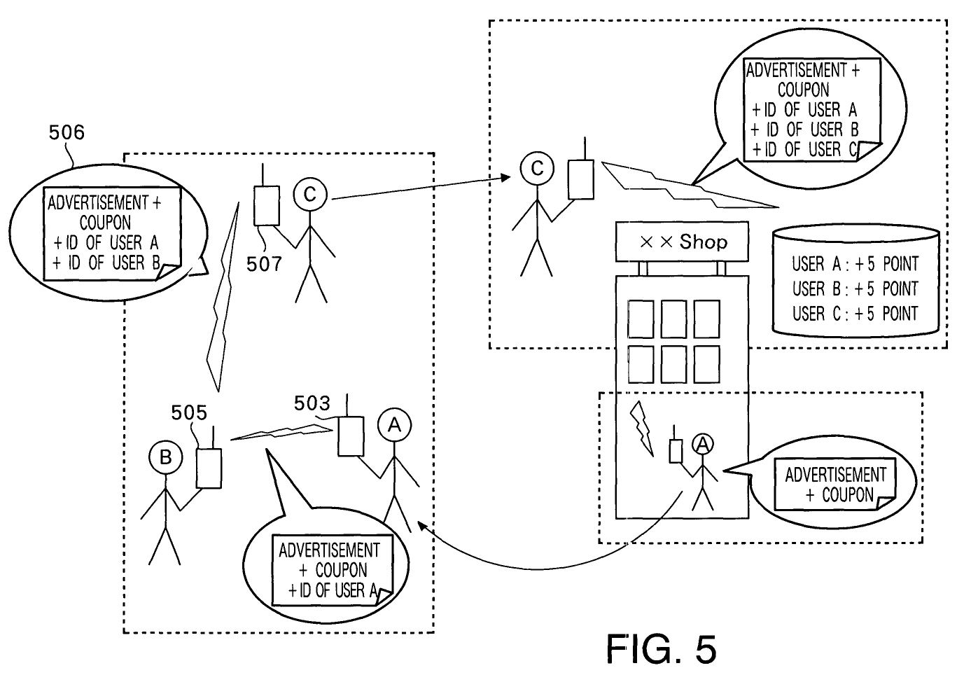

An example of a format for describing a list of information is also illustrated in FIG. 3 by 305. In the case of the example illustrated in list of information 305 in FIG. 5, the list has three pieces of information, a_denkiya.html, b_rental.html and c_restaurant.html. The relay terminal selects relevant information (for example, information of a shop whose member's card the user has) from the list 305, and transmits a transmission request.

The list 305 is described in XML (extensible Markup Language). XML is also a language standardized in World Wide Web Consortium.

As described above, according to the first embodiment, by providing benefits to users of relay terminal B 105 and relay terminal C 107, the users of relay terminals 105 and 107 start aggressively distributing and transmitting information to users of other relay terminals. In this way, the information is distributed and transmitted more frequently.

Further, according to the first embodiment, since the information is an electronic coupon with an advertisement, it is possible to distribute the advertisement in a wider range by providing benefits to users of information relay terminals and to anticipate increases in marquee effect.

(Second Embodiment)

In the second embodiment of the present invention, shops such as distributors and rental shops issue electronic coupons with advertisements. The shops provide points to purchasers of products, while providing benefits such as discounts to the purchasers corresponding to the number of points. Then, the shops provide benefits such as discounts to purchasers that present received electronic coupons.

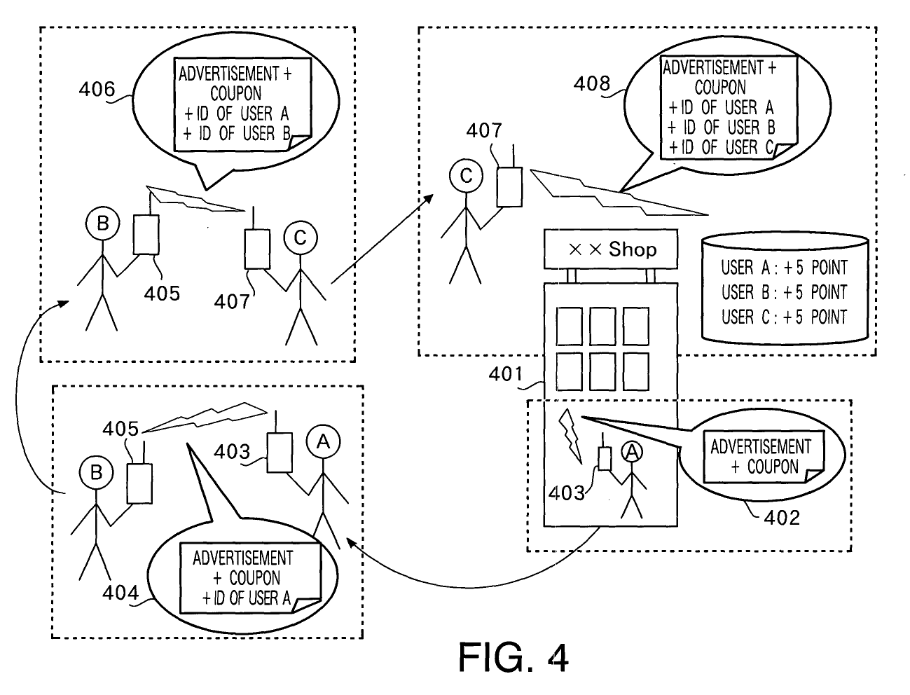

An information distribution system according to the second embodiment will be described below with reference to FIG. 4. FIG. 4 is a diagram illustrating a configuration of the information distribution system according to the second embodiment.

Relay terminal A 403 of user A receives electronic coupon with advertisement 402. Relay terminal A 403 may receive electronic coupon with advertisement 402 directly in shop 401 or receive the coupon 402 on WWW on the internet.

Subsequently, relay terminal A 403 moves to another location, and transmits electronic coupon with advertisement 404 provided with an ID of user A in shop 401 to relay terminal B 405 of user B, and relay terminal B 405 of user B receives the coupon 404.

Similarly, relay terminal B 405 moves to another location subsequently, and transmits electronic coupon with advertisement 406 provided with an ID of user B in shop 401 to relay terminal C 407 of user C, and relay terminal C 407 of user C receives the coupon 406.

User C refers to the advertisement of received electronic coupon with advertisement 408, and goes to shop 401 to purchase the product. When presenting the electronic coupon in purchasing the product, IDs of users A, B and C in shop 401 through which the electronic coupon with advertisement is passed are transmitted to shop 401. Shop 401 receiving the IDs adds points in users A, B and C and increases discount values for users A, B and C.

As described above, according to the second embodiment, users A and B are capable of increasing benefits such as discounts only by mediating distribution of an electronic coupon with an advertisement without going to shop A and purchasing the product. In this way, users of shop 401 start aggressively distributing electronic coupons with advertisements to increase benefits, and shop 401 is capable of promoting the distribution of product advertisements.

In addition, while the example as illustrated in FIG. 4 describes the aspect where each terminal receives information, moves while holding the information, and transmits the information, as illustrated in FIG. 5, relay terminal B 505 may promptly relay and transmit information received from relay terminal A 503, while adding ID 506 of user B.

Further, as one of examples of communication schemes used in the second embodiment, Bluetooth (for example, “Bluetooth Guidebook”, Miyazu, Kazuhiro, Nikkan Kogyo Shibunsha) may be used. However, there are other communication schemes such as IR LAN and wireless LAN, and the information distribution system is not limited in communication scheme.

Further, as in the aspect illustrated in FIG. 5, examples of a relay terminal relaying communications promptly include scatter-net in Bluetooth (for example, “Bluetooth Guidebook”, page 85, described earlier).

(Third Embodiment)

The third embodiment of the present invention is to provide road status obtained by collecting driving information of vehicles.

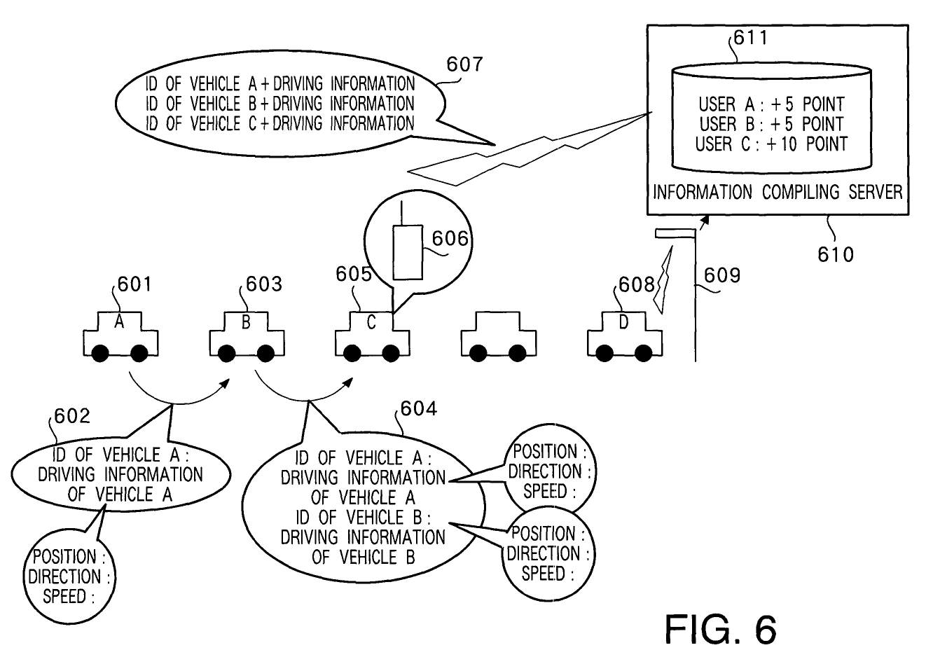

An information distribution system according to the third embodiment will be described below with reference to FIG. 6. FIG. 6 is a diagram illustrating a configuration of the information distribution system according to the third embodiment.

Vehicle A 601 provides a present position, moving direction and moving speed of the vehicle as driving information to information compiling server 610. The server 610 generates traffic jam information based on collected driving information to provide to users on a chargeable basis. As methods for a vehicle to transmit driving status, there are considered a scheme of using portable relay terminal 606 such as a cellular telephone as in vehicle C 605 and a DSRC (Dedicated Short Range Communications: for example “ITS Information Shower, Create Cruse Inc/DSRC system Lab.) scheme for communicating with antenna 609 installed on the side of a road as in vehicle D 608.

However, in cases of vehicles not provided with communication relay terminals or DSRC schemes, of vehicles driving in areas out of range of radio signal of cellular telephone, or of vehicles driving on roads on which road-side antennas of DSRC are not provided, it is not possible to transmit driving status to information compiling server 610.

In such cases, using inter-vehicle communications (for example, Nagai, Kiyoshi “Inter-vehicle Communication and Ranging System using FH/SS Technique” Technical Report of IEICE, ITS2000-17, page 37), the driving status is transmitted to a neighboring vehicle.

For example, vehicle A 601 transmits driving information 602 with an ID of the vehicle A to vehicle B 603, and vehicle B 603 receives the information with the ID. Vehicle B 603 adds driving information of vehicle B 603 to received driving information of vehicle A 601, and transmits driving information 604 to vehicle C 605. Then, vehicle C 605 receives driving information 604. Such operation is repeated.

Vehicle C 605 capable of transmitting driving information using portable relay terminal 606 adds driving information of vehicle C 605 to received driving information 604 having driving information of vehicles A 601 and B 603 to transmit to information compiling server 610. Information compiling server 610 generates road information based on received pieces of information of three vehicles, 601, 603 and 605, while adding point 611 to vehicles A 601, B 603 and C 605 that provide the information, so that point 611 can be used in getting a discount on a fee of provided road information, for example.

In addition, it may be possible to add a higher point to vehicle C 605 that finally transmits the information.

Further, it may be possible that provided road information is encrypted, a vehicle obtaining added points of a predetermined value is capable acquiring a decoding key effective in a term corresponding to the number of points, and thus the road information is provided only to vehicles that provide road information.

As described above, according to the third embodiment, in cases of poor communication environments such that a vehicle exists out of range of radio signal of cellular phone and that there are no road-side antennas of DSRC, it is possible for a vehicle to transmit driving information of the vehicle to information compiling server 610 due to relay by anther vehicle. It is thereby possible for information compiling server 610 to collect driving status of a larger number of vehicles. As a result, it is possible for information compiling server 610 to collect more pieces of information. Further, it is possible for vehicle users to acquire provided information with lower cost by providing information or relaying information. As a result, vehicle users aggressively distribute and relay the information, and information compiling server 610 is able to collect more pieces of information.

In the foregoing, the example is described that driving information on vehicles is collected using relay terminals mounted with the vehicles. However, relay terminals may be cellular telephones or PDAs or may be held by pedestrians, instead of being mounted with vehicles. Further, collected information is not limited to driving information of vehicle, and may be information on positions and movements of pedestrians or information on transmission amount such as the number of bytes of transmitted and received data per predetermined time in each relay terminal. Further, instead of transmitting collected information without processing, it may be possible to transform the information into a statistic amount such as the total value or average value of the information to transmit.

(Fourth Embodiment)

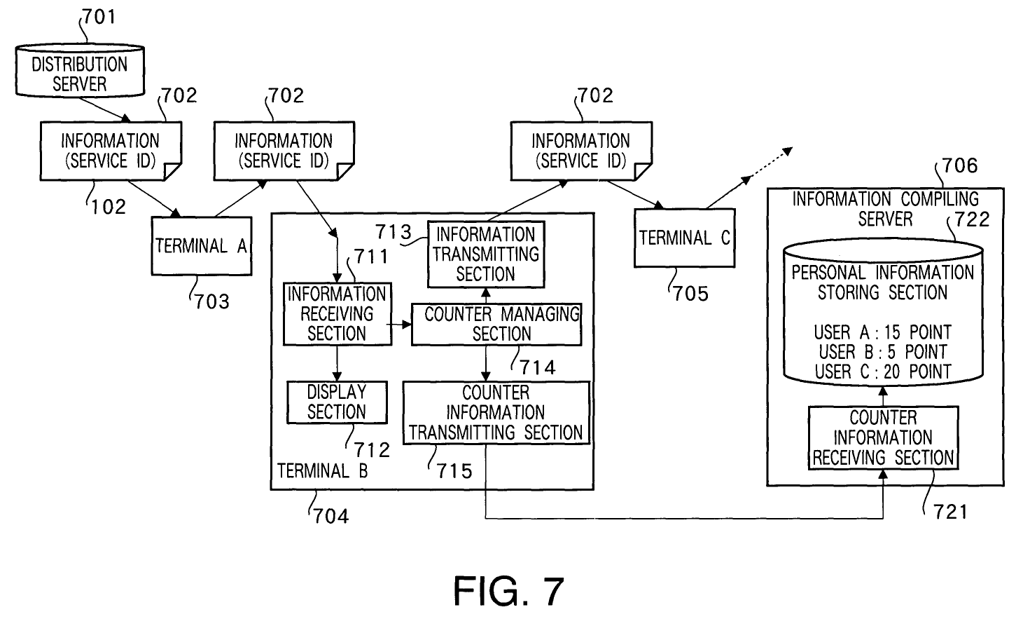

The fourth embodiment of the present invention will be described with reference to FIG. 7. FIG. 7 is a diagram illustrating a configuration of an information distribution system according to the fourth embodiment.

In the fourth embodiment, each of terminals A 703, B 704 and C 705 that receives information 702 transmitted from information distribution server 701 changes a counter value that each of the terminals holds in transmitting information 702 to relay, and transmits the counter value to information compiling server 706.

Transmission and reception of information performed by the relay terminals 703 to 705 includes the case that a receiving side requests a transmitting side to transmit the information and the case that a transmitting side transmits the information to a receiving side in one way, as described in the first embodiment.

Information 702 is assigned a service ID, and by referring to the service ID, it is possible to specify the content of information 702 such as a provider, issuer and kind of service (such as transmission of information, request for providing information and transmission of response to request) of information 702.

In addition, the content of information 702 may be only a service ID, given content (for example, a screen of advertisement and/or coupon) which users of relay terminals are capable of directly referring to, or given another information such as an address (URL) enabling the content to be referred to, genre and/or summary of provided information of service ID, the number of relays, upper limit of relay and expiration date. Further, by associating a service ID with a content address in a relay terminal in advance or providing such an association from a server, the provided information may be referred to only by receiving the service ID.

The processing in a relay terminal will be described with reference to relay terminal B 704 as an example.

In relay terminal B 704, information receiving section 711 receives information 702, and when information 702 has displayable information, display section 712 displays such information.

Further, in relay terminal 704 in transmitting information 702 to relay, counter managing section 714 changes the counter value corresponding to the service ID assigned to information 702, stores the number of times information of the service ID is relayed, and then transmits information 702 to information transmitting section 713.

In addition, the counter value may be changed in consideration of the time during which information 702 is held in relay terminal 704. For example, in the case of advertisement information requiring to be relayed promptly, the counter value is changed largely as the holding time is shorter. The degree of a change in counter value may be added to information 702 to be transmitted.

Further, in relay terminal B 704, when information 702 has the number of relay times information 702 has been relayed and reached or an upper limit of the number of relay times that indicates the number of allowable relay times, counter managing section 714 changes the number of relay times of information 702, and when the number of relay times exceeds the upper limit, does not transmit information 702 to relay.

Similarly, in the case where information 702 is given the expiration date indicative of an available period of information 702 and the current date exceeds the expiration data, relay terminal B 704 does not transmit information 702 to relay either.

Then, the counter information managed in counter managing section 714 as described above is transmitted from counter information transmitting section 715 to information compiling server 706. The information may be transmitted whenever a counter is changed, or transmitted at predetermined intervals (for example, every 24 hrs).

Information compiling server 706 receives the counter information in counter information receiving section 721, and using the information as point information of a corresponding user, changes the content of personal information storing section 722.

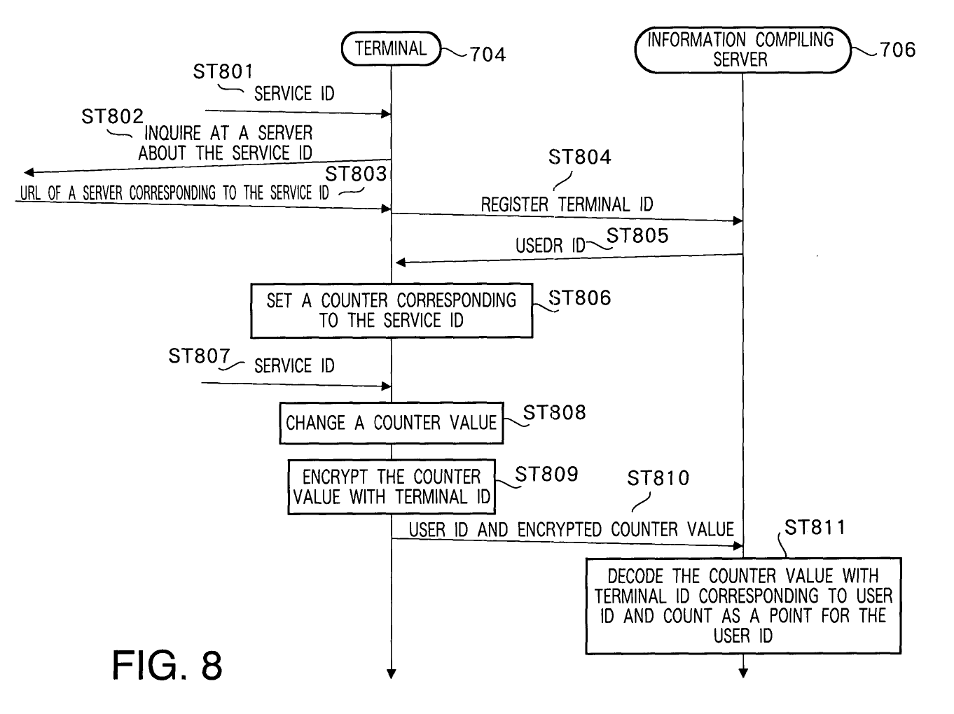

The processing when a relay terminal receives an unknown service ID is illustrated in FIG. 8. FIG. 8 illustrates a flowchart of the processing of a relay terming receiving an unknown service ID according to the fourth embodiment. It is herein assumed that relay terminal B 704 receives an unknown service TD.

When relay terminal B 704 receives an unknown service ID (ST801), inquires at a predetermined server about the service ID (ST802), and receives an address of a server corresponding to the service ID (ST803).

Relay terminal B 704 registers a specific identifier (relay terminal ID) of relay terminal B 704 with information compiling server 706 with the obtained address (ST804). Meanwhile, information compiling server 706 associates an identifier (user ID) for use in using the server with the received relay terminal ID to transmit to relay terminal B 704 (ST805).

Relay terminal B 704 receives the user ID from information compiling server 706, and associates the service ID corresponding to information compiling server 706 with the relay terminal ID to manage, while setting a counter corresponding to the service ID (ST806).

When relay terminal B 705 receives the same service ID as that received in ST801 (ST807), the terminal 705 changes an already set counter value to store (ST808).

In transmitting the stored counter value to information compiling server 706, relay terminal B 704 encrypts the counter value with the relay terminal ID as a key (ST809) to transmit together with the user ID (ST810).

In respond thereto, information compiling server 706 decodes the counter value using the relay terminal ID corresponding the received user ID as a key (ST811). When the decoding succeeds, information compiling server 706 regards that the counter value is transmitted from a proper relay terminal to count as a point for the user ID. Meanwhile, when the decoding fails, information compiling server 706 is able to determine that another user transmits a falsified user ID, and to manage the point safely.

Since the relay terminal ID is used as a key for encrypting and decoding, it is required to, for example, encrypt to transmit with security in registering the relay terminal ID.

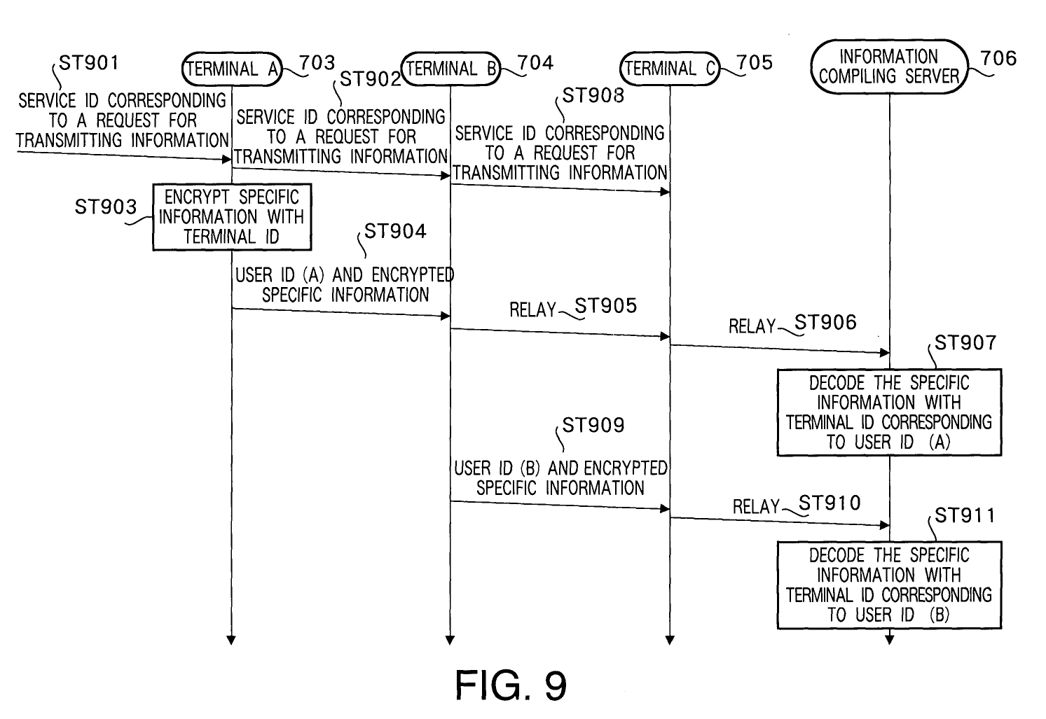

A flow of processing will be described with reference to FIG. 9 in which relay terminals transmit respective specific information of the relay terminals to a server. FIG. 9 illustrates a flowchart of processing in which relay terminals transmit respective specific information of the relay terminals to a server according to the fourth embodiment.

Relay terminal A 703 receives a service ID indicative of a request for transmitting specific information (ST901). Relay terminal A 703 changes the counter value, and transmits the received service ID to relay terminal B 704 (ST902). Further, relay terminal A 703 encrypts the specific information requested to transmit using the relay terminal ID of relay terminal A 703 as a key (ST903). The specific information is, for example, vehicle driving information in FIG. 6.

Relay terminal A 703 transmits the encrypted specific information, the user ID of relay terminal A 703 and service ID indicative of a request response (ST904).

Meanwhile, relay terminal B 704 and relay terminal C 705 relay the information from relay terminal A 703 (ST905 and ST906) so as to transmit to information compiling server 706.

Information compiling server 706 decodes the specific information using as a key the relay terminal ID corresponding to the received user ID of relay terminal A 703 to acquire (ST907).

Similarly, relay terminal B 704 having received the service ID by relay transmission changes the counter value, and transmits the received service ID to relay terminal C 705 (ST908). Relay terminal B 704 transmits specific information to relay terminal C 705 (ST909), and relay terminal C 705 relays the information (ST910).

Information compiling server 706 decodes the specific information using as a key the relay terminal ID corresponding to the received user ID of relay terminal B 704 to acquire (ST911).

It is thus possible to collect specific information of each terminal apparatus while preventing tampering by relay terminals.

As described above, according to the fourth embodiment, when a relay terminal transmits information to relay, the terminal changes a counter value, stores the number of times information of a service ID is relayed, and then transmits the information to information compiling server 706, and thus, information compiling server 706 is capable of providing benefits corresponding to the counter value to the relay terminal. In this way, users of relay terminals try to obtain more benefits by distributing and relaying more pieces of information, and the information can be distributed more effectively.

(Fifth Embodiment)

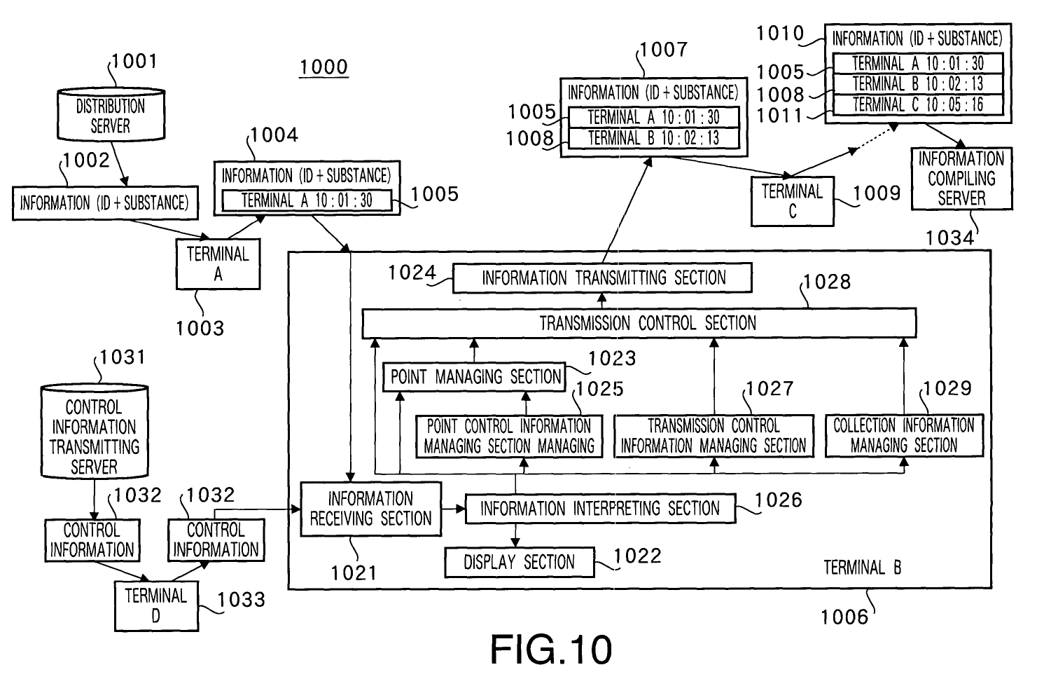

The fifth embodiment of the present invention will be described with reference to FIG. 10. FIG. 10 is a diagram illustrating a configuration of an information distribution system according to the fifth embodiment.

In information distribution system 1000 according to the fifth embodiment, information distribution server 1001 distributes information 1002 to relay terminal A (1003), and relay terminal A (1003) relays and distributes received information 1002 to relay terminal B (1006).

Information 1002 contains an ID of information and information substance. In addition, information 1002 may contain information of an address that enables access to the information substance, instead of the information substance.

When relaying information 1002 to relay terminal B (1006) to distribute, relay terminal A (1003) transmits information 1004 obtained by add an ID of relay terminal A (1003) and relay time 1005 as relay history information to information 1002.

In relaying (retransmitting) received information 1002 to relay terminal B (1006), relay terminal A (1003) obtains a reward point for relay/retransmission.

Relay terminal B (1006) receives information 1004, and displays information 1004 when necessary.

Relay terminal B (1006) relays received information 1004 to relay terminal C (1009) to distribute. When relaying information 1004 to relay terminal C (1009) to distribute, relay terminal B (1006) transmits information 1007 obtained by adding an ID of relay terminal A (1003) and relay time 1008 as relay history information to information 1004.

In retransmitting received information 1004 to another relay terminal, relay terminal B (1006) is capable of obtaining a reward point for retransmission.

Relay terminal C (1009) relays received information 1007 to information compiling server 1034 to distribute. In relaying information 1007 to information compiling server 1034 to distribute, the relay terminal C transmits information 1010 obtained by adding an ID of relay terminal C (1009) and relay time 1011 as relay history information to information 1007.

In retransmitting received information 1007 to information compiling server 1034, relay terminal C (1009) obtains a reward point for retransmission.

As described above, relay terminals A to C (1003, 1006 and 1009) are capable of obtaining reward points in relaying received information 1002, 1004 and 1007 to distribute, respectively.

As methods of managing reward points of relay terminals A to C (1003, 1006 and 1009), there are a method in which relay terminals A to C (1003, 1006 and 1009) add points to manage, and another method in which information compiling server 1034 receives relayed information (for example, 1010), and based on added relay history information (for example, 1005, 1008 and 1111), manages the points.

When relay terminals A to C (1003, 1006 and 1009) manage respective points, the terminals A to C (1003, 1006 and 1009) add points in relaying information to manage.

A method of adding points in relay terminals A to C (1003, 1006 and 1009) is determined based on point control information that the terminals manage. In addition, the point control information will be described later.

In addition, relay terminals A to C (1003, 1006 and 1009) may fixedly determine an amount of point to add, or determine different points corresponding to kind of relay terminal of a transmission source (information distribution server 1001, another relay terminals (1003, 1006 and 1009), etc.), kind of relay terminal as a destination of retransmission or communication medium (cellular telephone, wireless LAN, Bluetooth, etc.) used in retransmission.

Further, relay terminals A to C (1003, 1006 and 1009) may receive a method of determining an amount of point to add as control information 1032 separately from information 1004 (for example) from control information transmitting server 1031 or another relay terminal.

Furthermore, it may be possible that information distribution server 1001 transmits information 1002 provided with a method of determining an amount of point to add, and that relay terminals A to C (1003, 1006 and 1009) receives the method.

Information for enabling points to be added due to relaying information 1002, 1004 and 1007 received in relay terminals A to C (1003, 1006 and 1009) is included in information 1002, 1004 and 1007, respectively, or control information 1032.

Information distribution system 1000 allows changes in how to use points added due to information 1002, 1004 and 1007.

For example, relay terminals A to C (1003, 1006 and 1009) are capable of changing methods of presenting received information 1002, 1004 and 1007 corresponding to added points.

Specifically, only when a value of points added in relay terminals A to C (1002, 1004 and 1007) exceeds a predetermined value, information 1002, 1004 and 1007 can be displayed. Otherwise, displayable information is added to information 1002, 1004 and 1007, and only when a value of points added in relay terminals A to C (1002, 1004 and 1007) exceeds a predetermined value, the displayable information can be displayed.

In this way, relay terminals A to C (1003, 1006 and 1009) are capable of changing the content of information 1002, 1004 and 1007 to display corresponding to a value of points collectively managed. It is thereby possible for users of relay terminals A to C (1003, 1006 and 1009) to obtain benefits, such as receipt of presentation of particular information, by carrying out relay of information a large number of times. As a result, the users of relay terminals A to C (1003, 1006 and 1009) start aggressively relaying information 1002, 1004 and 1007.

Further, by transmitting a predetermined number of points to information compiling server 1034, relay terminals A to C (1003, 1006 and 1009) are capable of acquiring rights to obtain specific information from an information distributor and/or rights to exchange information with another user.

Thus, relay terminals A to C (1003, 1006 and 1009) are able to obtain rights of acquisition and/or exchange of information related to information 1002, 1004 and 1007 corresponding to a value of reward points collectively managed. It is thus made possible fro users of relay terminals A to C (1003, 1006 and 1009) to acquire benefits such that the users obtain new information from, for example, users of other information relay terminals through electronic communications including a mailing list and message board, by performing relay of information a large number of times.

Information distribution system 100 enables relay terminals A to C (1003, 1006 and 1009) to control timing of retransmission and the presence of absence of retransmission in retransmitting information 1002, 1004 and 1007, respectively.

Among methods of controlling timing of retransmission is a method, for example, using a relay waiting time between receiving information and retransmitting the information, moving distance or the number of moving steps until retransmission, or the limitation number of times the same information is retransmitted.

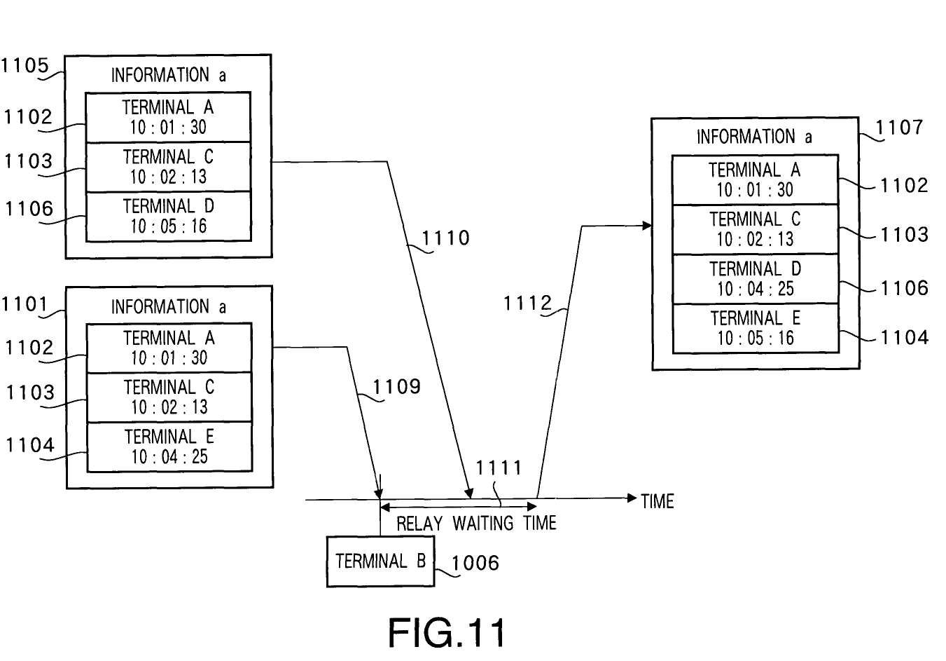

Referring to FIG. 11, a case will be described where a relay waiting time is set and relay terminal B (1006) retransmits information. In addition, while the description is herein given on relay terminal B (1006), relay terminals A and C (1003 and 1009) perform the same operation.

Relay terminal B (1006) receives information a (1101) at time 1109. Information a (1101) contains as re history information IDs and relay times (1102 to 1104) respectively of relay terminals A, C and E that have relayed.

Relay terminal B (1006) receives information a (1101) at time 1109, and then, does not perform redistribution for relay waiting time 1111.

Relay waiting time 1111 corresponds to time taken for relay terminal B (1006) to move a predetermined distance, or time taken for a user carrying a relay terminal provided with a pedometer to move a predetermined number of steps.

Next, relay terminal B 1006 receives information a (1105) having another relay history information (1102, 1103 and 1106 (ID and relay time of relay terminal D)) at time 1110 during relay waiting time 1111.

In this case, relay terminal B (1006) generates information a having relay history information (1102 to 1104 and 1106) contained in information a (1101) and information a (1105).

However, when relay terminal B (1006) simply adds relay history information (1102 to 1104 and 1106) contained in informational (1101) and information a (1105), relay history information (1102 and 1103) overlaps. Therefore, as the relay history information, relay terminal B (1006) generates information a (1107) having relay history information (1102 to 1104) contained in information a (1101) and relay history information (1106) that is not contained in information a (1101) among information history information (1102, 1103 and 1106) contained in information a (1105).

Relay terminal B (1006) retransmits information a (1107) at time 1112 after a lapse of relay waiting time 1111.

In this way, it is possible to prevent congestion on a communication path caused by transmitting a plurality of pieces of same history information (1102 and 1104).

Information distribution system 1000 sets the limit number of retransmission times to limit retransmission of the same information. The purpose is to limit the number of information transmission times to a predetermined number of times in relay terminals A to C (1003, 1006 and 1009), irrespective of whether or not relay waiting time 1111 is set in information. In other words, when each of relay terminals A to C (1003, 1006 and 1009) receives information whose number of retransmission times exceeds a predetermined number of times, the terminal discards the information or stops retransmitting the information to a relay terminal. In this way, similarly, it is possible to prevent congestion on a communication path caused by transmitting a plurality of pieces of same history information.

A method of controlling retransmission of information may be determined in advance in relay terminals A to C (1003, 1006 and 1009), or may be added to information. Further, relay terminals A to C (1003, 1006 and 1009) may receive a method of controlling retransmission of information as control information 1032 separately from the information directly from control information transmitting server 1031 or from another relay terminal.

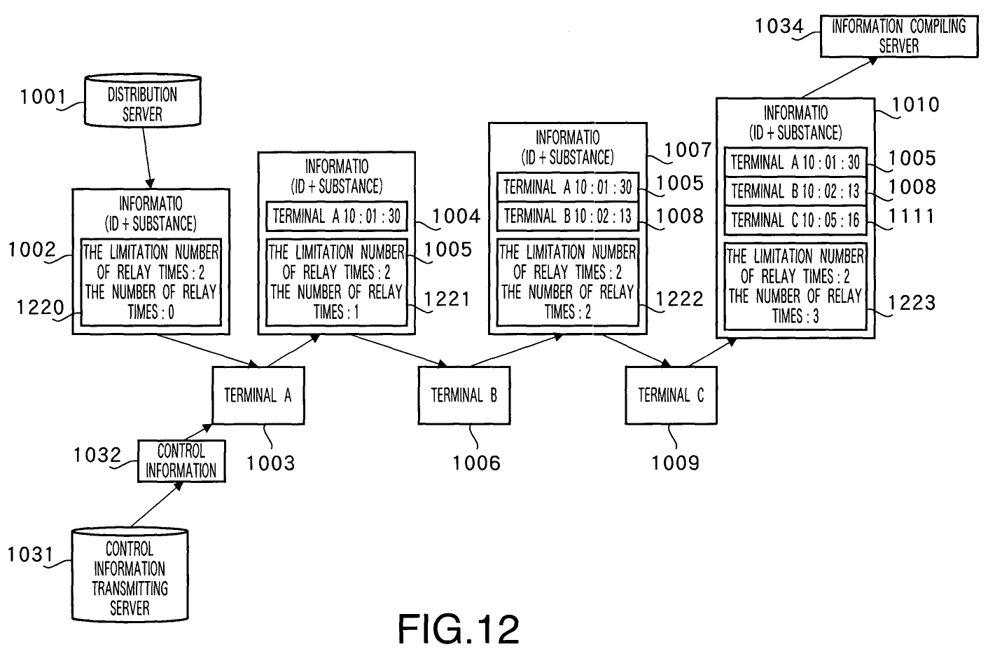

Processing will be described with reference to FIG. 12 in which relay terminals A to C (1003, 1006 and 1009) receive the method of controlling retransmission of information from control information transmitting server 1031 as control information 1032.

FIG. 12 illustrates an example of case where information compiling server 1034 manages reward points.

Information 1002 that information distribution server 1001 distributes is provided with relay information 1220 indicative of the number of relay imitation times and the number of relay times.

Relay terminals A to C (1003, 1006 and 1009) receive information for controlling whether received information 1002 is transferred to information compiling server 1034 or retransmitted to another relay terminal as control information 1032 from control information transmitting server 1031 or as information 1002 provided with such information.

In the example in FIG. 12, control information 1032 is indicative of the limitation number of relay times. In addition, control information 1032 may include the number of relay terminals subject to relay limitation, relay expiration date, and/or server transfer expiration date.

As in the example illustrated in FIG. 12, in the case where relay terminal A 1003 receives information 1002 for which the limitation number of relay times is set, in retransmitting information 1002 distributed from information distribution server 1001, the terminal 1003 retransmits information 1004 obtained by adding relay history information 1221 containing the number of relay times incremented by 1 from that in relay information 1220 to information 1002.

In retransmitting information 1004, relay terminal B 1006 retransmits information 1007 obtained by adding relay history information 1222 containing the number of relay times of 2 changed from that in relay information 1221 to information 1004.

Relay terminal C 1009 generates information 1010 obtained by adding relay history information 1223 containing the number of relay times of 3 changed from that in relay information 1222 to information 1007. In information 1010, the number of relay times of 3 exceeds the limitation number of relay times of 2.

Accordingly, relay terminal C 1009 determines whether to stop retransmitting information 1010 to another relay terminal or transmitting information 1010 to information compiling server 1034 instead of another relay terminal. In addition, relay terminal C 1009 determines a distribution destination of information 1010 based on the terminal 1009 or control information 1032.

In this way, it is possible to converge the distribution of information 1010, and to prevent occurrences of a case where relay history information (1221 to 1223) is not transferred to information compiling server 1034 for a long time and rewarding points are not be effective.

In addition, the control of retransmission enables elimination of a case where the same relay terminal relays the information at a plurality of times by limiting the number of relay terminals that carry out the relay, instead of using the number of relay times. Further, instead of using the number of relay times, an expiration date may be used to limit. Furthermore, it may be possible to set separately a relay expiration date until which information can be relayed and referred to, and a server transfer expiration data until which information is transferred to a server with an effective reward point.

As described above, in the information distribution system according to the fifth embodiment, information is relayed and distributed.

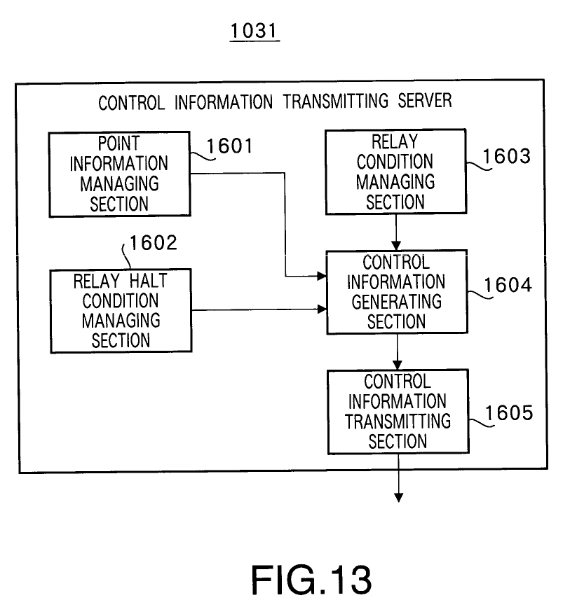

A configuration of control information transmitting server 1031 according to the fifth embodiment will be described below with reference to FIG. 13. FIG. 13 is a diagram illustrating the configuration of control information transmitting server 1031.

Control information transmitting server 1031 has point information managing section 1601 that stores and manages point information that is information composes control information. The server 1031 further has relay halt condition managing section 1602 that stores and manages relay halt condition that is information composes the control information. The server 1031 further has relay condition managing section 1603 that stores and manages a relay condition that is information composes the control information.

Control information transmitting server 1031 further has control information generating section 1604 that generates the control information from the point information, relay halt condition and relay condition.

In addition, point information, relay halt condition, relay condition and control information will be described specifically later.

Control information transmitting server 1031 further has control information transmitting section 1605 that transmits the control information generated in control information generating section 1604 to other relay terminals.

By thus configuring control information transmitting server 1031, it is possible for the server 1031 to control the method of relaying information in relay terminals. Further, it is possible for the server 1031 to control the relay of information so that information whose relay by relay terminals is finished is transferred to information compiling server 1034.

In addition, it may be possible that relay terminal B 1006 transmits information on a transmission amount of received information 1004 or transmitted information 1007 to control information transmitting server 1031 and that the server 1031 receives the information.

In this way, based on the transmission amount caused by information relay, control information transmitting server 1031 is capable of controlling a method of relaying information in relay terminal B 1006 so as to reduce the transmission amount.

Relay terminal B 1006 transmits information on the transmission amount to control information transmitting server 1031 when the transmission amount exceeds a predetermined level, whereby control information transmitting server 1031 is capable of controlling the method of relaying information when the transmission amount of information is not normal.

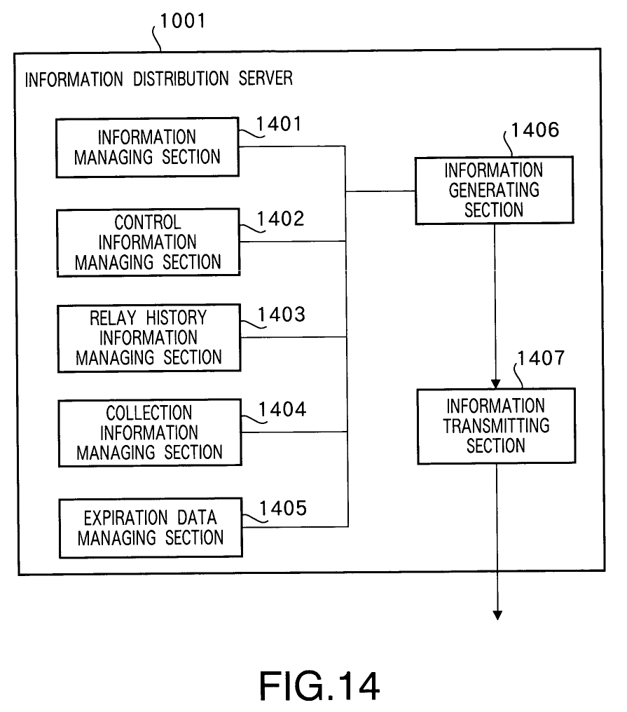

A configuration of information distribution server 1001 will be described with reference to FIG. 14. FIG. 14 is a diagram illustrating the configuration of information distribution server 1001 according to the fifth embodiment.

Information distribution server 1001 has information managing section 1401 that manages the information substance to distribute, control information managing section 1402 that manages the control information to be added to information to distribute, relay history information managing section 1403 that manages relay history information to be added to the information to distribute, collection information managing section 1404 that manages collection information to be added to the information to distribute, and expiration data managing section 1405 that manages an expiration date to be added to the information to distribute.

Information distribution server 1001 further has information generating section 1406 that generates information 1002 to distribute to other relay terminals, from the information substance managed in information managing section 1401, control information managed in control information managing section 1402, relay history information managed in relay history information managing section 1403, collection information managed in collection information managing section 1404, and expiration date information managed in expiration data managing section 1405.

Information distribution server 1001 further has information transmitting section 1407 that transmits generated information 1002 to other relay terminals.

In addition, the information substance, control information, relay history information, collection information and expiration data information will be described specifically later.

Information distribution server 1001 is configured as described above.

A configuration of relay terminal B (1006) will be described below with reference to FIG. 10. In addition, although only relay terminal B (1006) will be described specifically, relay terminal A (1003) and relay terminal C (1009) each have the same configuration as that of relay terminal B.

Relay terminal B 1006 has information receiving section 1021 that receives information and control information transmitted from other relay terminals.

Relay terminal B 1006 further has information interpreting section that interprets information 1004 and control information 1032 received in information receiving section 1021.

When received information 1004 contains display information, information interpreting section 1026 outputs the information to display section 1022, and the section 1022 displays the information.

When received information 1004 contains control information 1032, information interpreting section 1026 interprets a kind of the control information, and outputs point information of the control information to point information managing section 1025, while outputting transmission control information (relay condition and relay halt condition) of the control information to transmission control information managing section 1027.

When received information 1004 contains a command for collecting information, information interpreting section 1026 outputs the command to collection information managing section 1029.

Point control information managing section 1025 manages and stores the point information output form information interpreting section 1026.

Transmission control information managing section 1027 manages and stores the transmission control information output form information interpreting section 1026.

Collection information managing section 1029 collects required information from the received collection information to generate information in the form to be added to information 1004. Collection information managing section 1029 substitutes compiling information having the received collection information and collection information on relay terminal B 1006 for the collection information added to information 1004. It is thus possible to prevent increases in transmission amount caused by storage of collection information.

When relay terminal B (1006) manages points due to relay distribution, point managing section 1023 adds points to manage. Point managing section 1023 determines a method of adding points based on the point control information managed in point control information managing section 1025.

Relay terminal B 1006 further has transmission control section 1028 that controls information transmitting section 1024 that transmits information, so as to control retransmission of information. In retransmitting information, transmission control section 1028 controls timing of retransmission and whether or not to retransmit, based on the transmission control information managed in transmission control information managing section 1027.

Transmission control section 1028 adds the collection information generated in collection information managing section 1029 in retransmitting information.

It is thus possible for information compiling server 1034 to collect information by using relay terminal B 1006 with which the server 1034 does not communicate directly.

Relay terminal B 1006 is configured as described above.

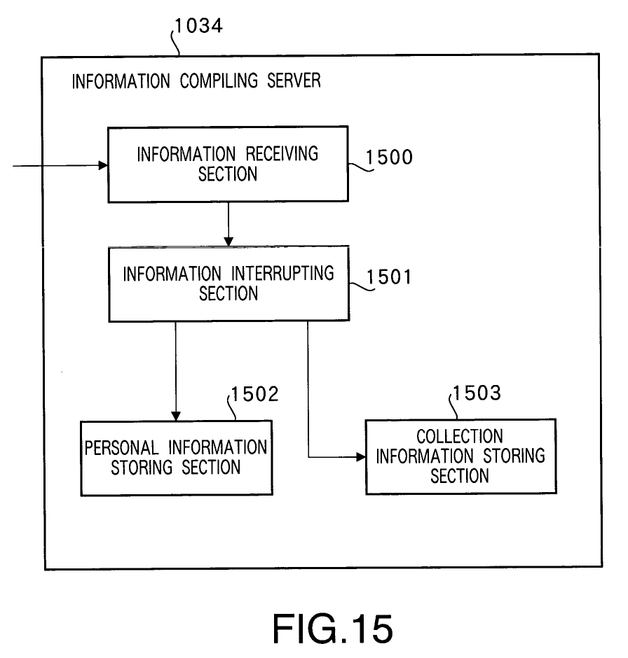

A configuration of information compiling server 1034 will be described below with reference to FIG. 15. FIG. 15 is a diagram illustrating the configuration of information compiling server 1034 according to the fifth embodiment.

Information compiling server 1034 has information receiving section 1500 that receives information and collection information. Information receiving section 1500 outputs received information and collection information to information interrupting section 1501.

Information interrupting section 1501 interrupts the information and collection information. Specifically, information interrupting section 1501 adds a reward point for a relay terminal based on the relay history information added to the information, and outputs an added reward point to personal information storing section 1502. Further, information interrupting section 1501 outputs the collection information to collection information storing section 1503.

Personal information storing section 1502 compiles and manages the provided reward point. Collection information storing section 1503 stores the provided collection information.

Information compiling server 1034 is configured as described above.

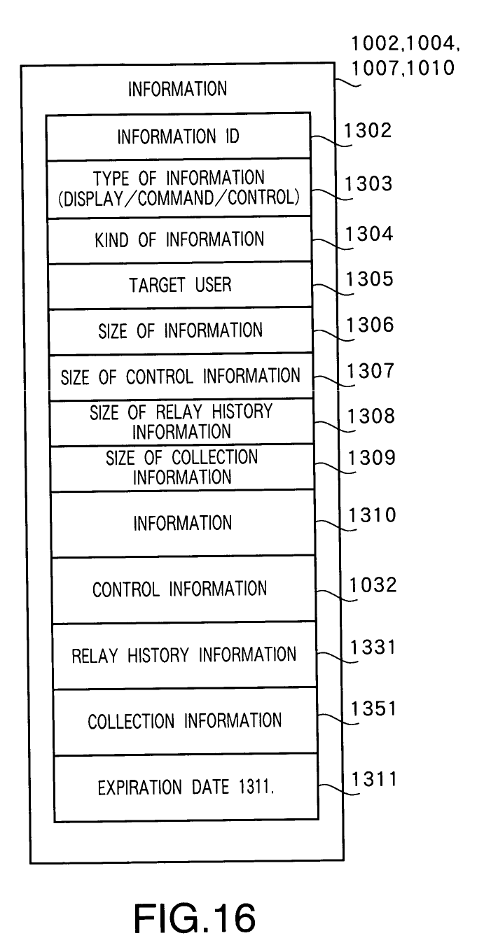

Structures of information 1002, 1004, 1007 and 1010 transmitted from information distribution server 1001 will be described with reference to FIG. 16.

Information 1002 is comprised of ID 1302 specific to information, type of information 1303 indicating that information is display information, a command for collecting information or control information, kind of information 1304, user targeted for information 1305, size of information 1306, size of control information 1307, size of relay history information 1308, size of collection information 1309, information substance or address 1310, control information 1032, relay history information 1331, collection information 1351 and expiration date 1311.

Control information 1032 is the same as control information that control information transmitting server 1031 transmits.

Information substance 1310 may contain information of an address that enables access to the information substance, instead of the information substance.

User targeted for information 1305 may contain no description.

Information 1002 is configured as described above.

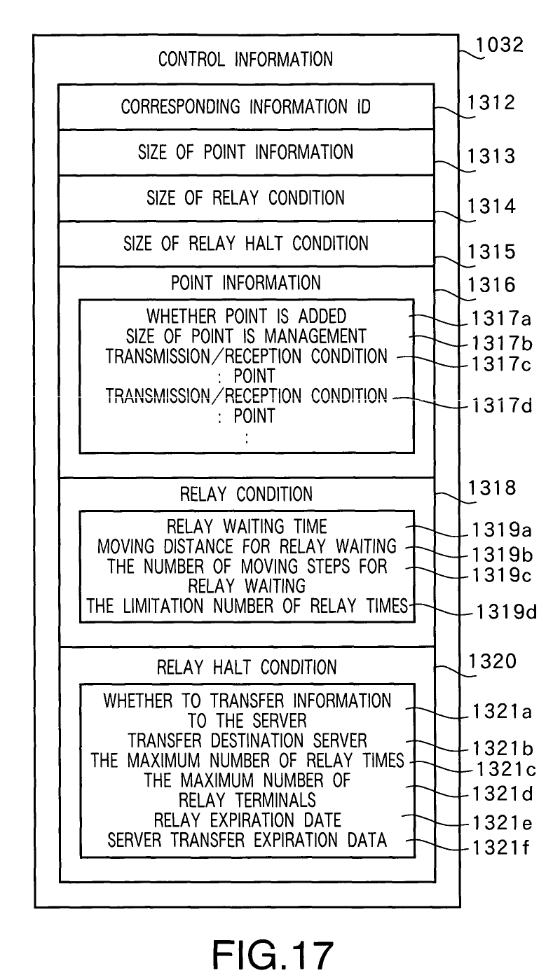

Control information 1032 will be described with reference to FIG. 17. FIG. 17 is a diagram illustrating control information 1032.

Control information 1032 is comprised of ID of information targeted for control 1312, size of point information 1313, size of relay condition 1314, size of relay halt condition 1315, point information 1316, relay condition 1318 and relay halt condition 1320.

Point information 1316 is comprised of information 1317a indicating whether a point is added in relaying information 1002, 1004, 1007 and 1010, site information 1317b indicating a site (relay terminal or information compiling servers) for managing points, and 1317c and 1317d each indicating transmission/reception condition (transmission means) and point to add in response to the condition.

In this way, point information 1316 has information 1317a that indicates whether a point is added in relaying information 1002, 1004, 1007 and 1010, whereby relay terminals A to C (1003, 1006 and 1009) are capable of determining whether or not to compile reward points by retransmitting received information.

Further, since point information 1316 has 1317c and 1317d each of which indicates transmission/reception condition (transmission means) and point to add in response to the condition i.e. a method of adding points in relaying information 1002, 1004, 1007 and 1010, information distribution server 1001 is capable of controlling the method of adding reward points in relay terminals A to C (1003, 1006 and 1009).

Furthermore, by preparing different values as reward points with kind of information relay terminal as a transmission destination or kind of transmission path on which information is transmitted and received, information relay terminals are able to obtain different reward points by selecting communication methods with different communication fees.

Relay condition 1318 is comprised of relay waiting time 1319a to elapse between receiving and retransmitting information, moving distance for relay waiting 1319b, the number of moving steps for relay waiting 1319c and the limitation number of relay times 1319d that is the number of times to limit retransmission of information.

In this way, relay condition 1318 has relay waiting time 1319a, moving distance for relay waiting 1319b, and the number of moving steps for relay waiting 1319c, whereby it is possible for relay terminals A to C (1003, 1006 and 1009) to retransmit information after a lapse of predetermined time, moving a predetermined distance, or moving for the predetermined number of steps, since information was received. Further, since relay condition 1318 has the limitation number of relay times 1319d, information can be retransmitted a plurality of number of times.

By thus adding information for limiting retransmission of information, it is possible to prevent increases in transmission amount caused by transmitting the same information repeatedly.

Relay halt condition 1320 has information 1321a indicative of whether or not to transfer information to information compiling server 1034, ID of a server as a transfer destination 1321b, the maximum number of information relay times 1321c, the maximum number of relay terminals 1321d, relay expiration date 1321e, server transfer expiration data for information 1321f, and other information such as an address and encrypting key.

By thus providing relay halt condition 1320, it is possible to prevent information from being relayed continuously and to prevent the relay history information from being not reflected in the information compiling server.

Control information 1032 is configured as described above.

In addition, with respect to control information 1032 (including relay waiting time until retransmission, moving distance or the number of moving steps for relay waiting, the limitation number of times the same information is retransmitted, the limitation number of relay times, the number of relay terminals to limit relay, relay expiration date, and server transfer expiration date), control information transmitting server 1031 may change the setting corresponding to states to re-distribute. For example, the control information transmitting server collects the number of transmission bytes in each relay terminal, checks a state of congestion on transmission paths, decreases the limitation number of retransmission times or sets an earlier expiration date when the paths are congested, and thus enables improvements in congestion.

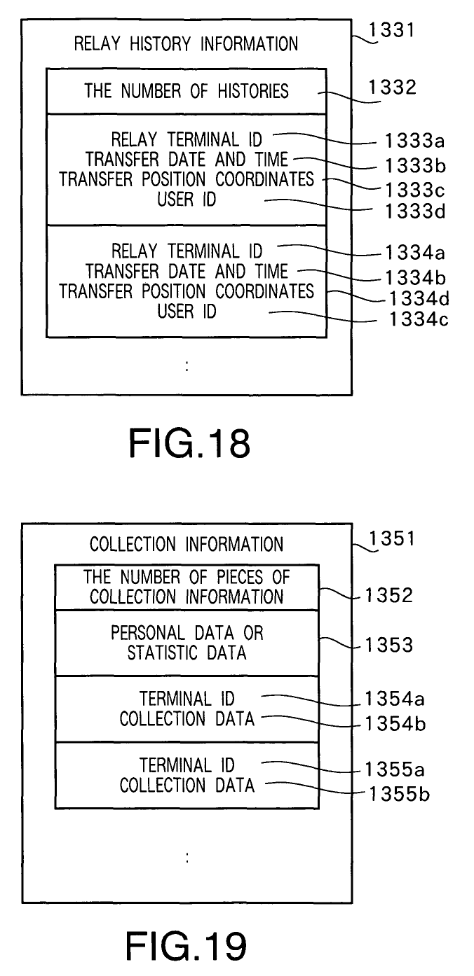

Relay history information 1331 will be described with reference to FIG. 18. FIG. 18 is a diagram illustrating relay history information 1331.

Relay history information 1331 is comprised of the number of histories 1332, relay terminal IDS 1333a and 1334a, transfer dates and times 1333b and 1334b, transfer position coordinates (latitudes and longitudes) 1333c and 1334c and user IDs 1333d and 1334d, where the numbers of IDs or others corresponds to the number of histories 1332.

Relay history information 1331 is configured as described above.

Collection information 1351 will be described with reference to FIG. 19. FIG. 19 is a diagram illustrating collection information 1351.

Collection information 1351 is comprised of the number of pieces of collection information 1352, and information 1353 that indicates whether the collection information is personal data or statistic data, and when the collection information is personal data, further of relay terminal IDs 1354a and 1355a and collection data 1354b and 1355b respectively corresponding to IDs 1354a and 1355a.

Collection data 1354b and 1355b includes information on transmission amounts of information 1002, 1004 and 1007. It is thereby possible for information distribution server 1001 to collect transmission amounts in transmission environments through which information is distributed to reflect in control of information relay.

Collection information 1351 is configured as described above.

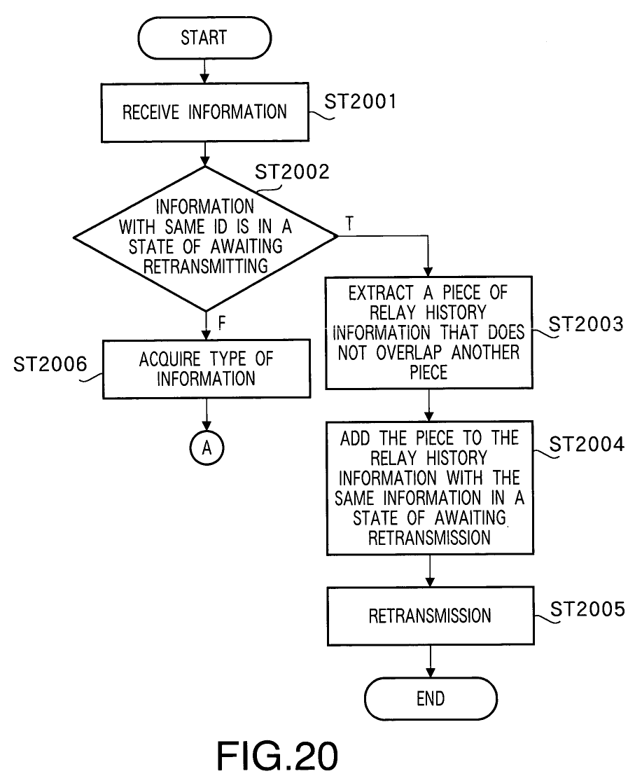

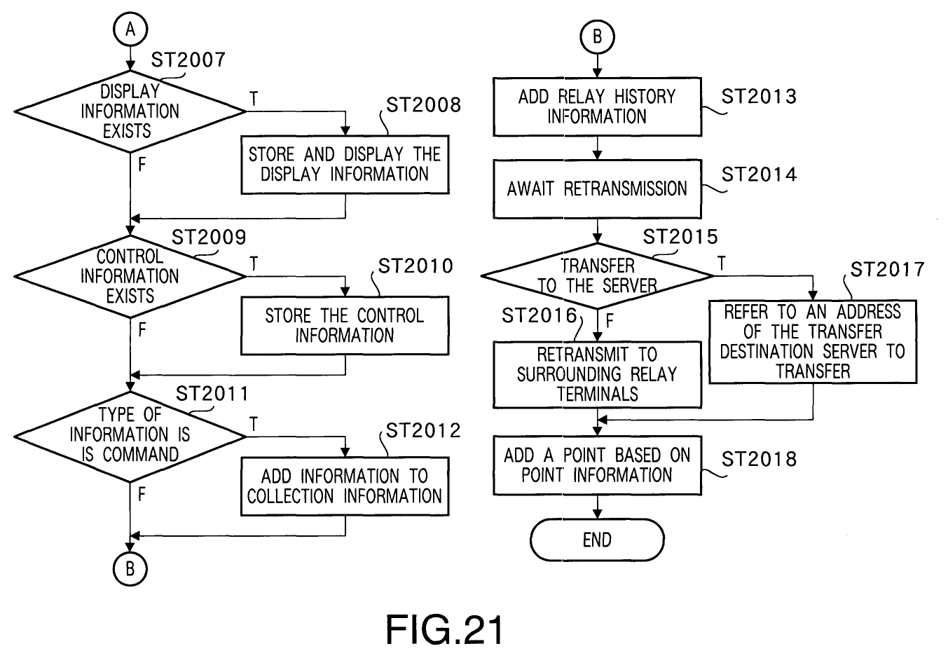

Referring to FIG. 20, the operation will be described where relay terminal B (1006) receives information 1004. In addition, although specific descriptions are given only on relay terminal B (1006), when receiving information 1002 and 1007, respectively, relay terminal A (1003) and relay terminal C (1009) perform the same operation as in relay terminal B (1006) receiving information 1004.

In relay terminal B (1006), information receiving section 1021 receives information 1004 (ST2001). Information receiving section 1021 outputs received information 1004 to information interpreting section 1026.

Information interpreting section 1026 refers to ID 1302 of received information 1004, and determines whether information with the same ID as ID 1302 is already received and whether a state is of awaiting retransmission (ST2002).

When the information with the same ID as ID 1302 is already received and a state is of awaiting retransmission, transmission control section 1028 extracts relay history information 1331 from information 1004 received in ST2001. Next, transmission control section 1028 extracts a piece of relay history information 1331 that does not overlap another piece of relay history information 1331 that is already received from among extract pieces of relay history information (ST2003).

Transmission control section 1028 adds the piece of relay history information 1331 that does not overlap one another to the received pieces of relay history information 1331 (ST2004).

Specifically, transmission control section 1028 adds terminal IDs 1333a and 1334a, transfer dates and times 1333b and 1334b, transfer position coordinates 1333c and 1334c and user IDs 1333d and 1334d each of which overlaps one another.

In this way, even when the same information is passed through a plurality of different paths, it is possible to delete an overlapping relay history and to reduce transmission amounts of relay history information.

Transmission control section 1028 refers to relay waiting time 1319a of control information 1032 contained in information 1004, and retransmits information with updated relay history information after a lapse of relay waiting time 1319a (ST2005).

Meanwhile, when determining that information with the same ID as ID 1302 is not received in ST2002, information interrupting section 1026 acquires type of information 1303 of information 1004 (ST2006).

Then, information interrupting section 1026 analyzes type of information 1303, determines whether information 1004 has display information that is displayable (ST2007), and when the display information exists, outputs the display information to display section 1022. Display section 1022 stores the output information to display (ST2008).

Further, information interrupting section 1026 analyzes type of information 1303, determines whether information 1004 has control information 1032 (ST2009), and when control information 1032 exists, outputs point information 1316 of control information 1032 to point control information managing section 1025, while outputting relay condition 1318 and relay halt condition 1320 to transmission control information managing section 1027. Point control information managing section 1025 and transmission control information managing section 1027 store the provided information (ST2010).

In addition, in relay terminal B 1006, when information 1004 does not have control information 1032, information receiving section 1021 receives control information 1032 transmitted from control information transmitting server 1031, and information interrupting section 1026 analyzes the information 1032, and outputs point information 1316 to point control information managing section 1025, while outputting relay condition 1318 and relay halt condition 1320 to transmission control information managing section 1027.

Information interrupting section 1026 further analyzes type of information 1303, determines whether information 1004 has command information for collecting collection information 1351 (ST2011), and when the command information for collecting collection information 1351 exists, outputs collection information 1351 to collection information managing section 1029. Collection information managing section 1029 adds information such as relay terminal information of the terminal 1006 to collection information 1351 (ST2012).

Next, relay terminal B (1006) shifts to processing for relaying information 1004.

In relay terminal B (1006), transmission control section 1028 refers to relay history information 1331 contained in information 1004. Transmission control section 1028 adds relay terminal ID 1333a of the terminal 1006, transfer data and time 1333b, transfer position coordinate 1333c and user ID 1333d to relay history information 1331 (ST2013).

Transmission control section 1028 refers to relay waiting time 1319a of relay condition 1318 of information 1004, and waits for retransmission (relay) for relay waiting time 1319a (ST2014).

Transmission control section 1028 refers to relay halt condition 1320 after a lapse of relay waiting time 1319a, and when relay halt condition is met, relays information 1004 to surrounding relay terminals. Meanwhile, when the status is beyond relay halt condition 1320, transmission control section 1028 halts the relay and determines to transmit the information to information compiling server 1034 (ST2015).

When it is determined that information 1004 is relayed to surrounding relay terminals in ST2015, transmission control section 1028 retransmits the information to surrounding relay terminals through information transmitting section 1024 (ST2016).

Meanwhile, when it is determined that information 1004 is relayed to information compiling server 1034 in ST2015, transmission control section 1028 refers to an address of information compiling server 1034 from transfer destination server 1321b of relay halt condition 1320. Then, transmission control section 1028 directly transfers information 1004 to information compiling server 1034, or encrypts the information with an encrypting key of the information compiling server to retransmit (ST2017).

Next in relay terminal B 1006, point managing section 1023 refers to point information 1316. Based on site information 1317b indicating a site for managing points in point information 1316, point managing section 1023 determines whether points are managed in relay terminal B 1006 or in information compiling server 1034. When relay terminal B 1006 manages points, point managing section 1023 adds a point. When information compiling server 1034 manages points, point managing section 1023 transmits added point 1317 to information compiling server 1034 through transmission control section 1028 and information transmitting section 1024 to update (ST2018).

Thus, relay terminal B 1006 is able to obtain reward points for relaying information without communicating with servers including information distribution serer 1001. As a result, a user of relay terminal B starts aggressively relaying the information, enabling distribution of the information in a wide range. Further, relay terminal B 1006 does not need to communicate with servers including information distribution serer 1001, the present invention is applicable to inter-terminal communication using short-distance wireless communications such as Bluetooth.

As described above, according to the fifth embodiment, it is possible to provide benefits to users that relay and distribute information and users that provide new information. As a result, for the purpose of obtaining the benefits, the users start aggressively relaying and distributing information or providing information, relay distribution or provision of information is thus accelerated, and the effect on information propagation is enhanced.

As described above, according to the present invention, by providing benefits to users of information relay terminals, it is made possible to distribute and transmit information widely. When information is an electronic coupon with an advertisement, it is possible to distribute the advertisement in a wider range by providing benefits to users of information relay terminals, and to anticipate increases in marquee effect. When information is driving information of vehicle, by providing benefits to users of information relay terminals, it is possible to increase persons who provide driving information, and to anticipate increases in users of road information providing service and improvements in accuracy in road information.

The present invention is not limited to the above described embodiments, and various variations and modifications may be possible without departing from the scope of the present invention.

This application is based on the Japanese Patent Applications No.2002-201563 filed on Jul. 10, 2002, and No.2003-168426 filed on Jun. 12, 2003, entire contents of which are expressly incorporated by reference herein.

What is claimed is:

1. An information relay terminal comprising:
an information receiver that receives information transmitted from an information distribution server that distributes the information or another information relay terminal;
an information transmitter that retransmits the information received; and
a point manager that adds a reward point for receiving and retransmitting the information and that manages compilation of the reward point.

2. The information relay terminal according to claim 1, wherein the terminal receives point information indicating that the reward point is provided for receiving and retransmitting the information.

3. The information relay terminal according to claim 1, wherein the terminal receives point information indicating that a method of providing the reward point, and based on the point information, manages compilation of the reward point.

4. The information relay terminal according to claim 1, wherein content of the information to present differs corresponding to amount of the reward point compiled and managed.

5. The information relay terminal according to claim 1, wherein the terminal obtains a right to acquire or exchange information related to the information received and retransmitted corresponding to amount of the reward point compiled and managed.

6. The information relay terminal according to claim 1, wherein the information is provided with relay history information, and in receiving new information having the same substance as that of the information already received before retransmitting the information already received, the terminal adds, to the information already received, a piece of the relay history information that is not contained in the information already received among nieces of the relay history information added to the new information.

7. The information relay terminal according to claim 1, further comprising:
a transmission control information manager that manages transmission control information to retransmit the information received; and
a transmission controller that controls the information transmitter based on the transmission control information to cause the information transmitter to retransmit the information received.

8. The information relay terminal according to claim 7, wherein the relay history information includes either a relay waiting time to elapse between receiving and retransmitting the information, moving distance or the number of moving steps, or the number of relay times indicative of the limitation number of times the same information is retransmitted.

9. The information relay terminal according to claim 7, wherein the relay history information is server transfer control information to transmit the information to an information compiling server that compiles the information, and based on the server transfer control information, the transmission controller transmits the information to the information compiling server.

10. The information relay terminal according to claim 9, wherein the server transfer control information includes either the number of relay times the information has been relayed, the number of information relay terminals that have relayed the information, a relay expiration date until which the relay is available, or a server transfer expiration date until which the information is capable of being transferred to the server.

11. The information relay terminal according to claim 7, wherein the terminal receives the relay control information from a control information transmitting server separately from the information.

12. The information relay terminal according to claim 11, wherein the terminal transmits information on a transmission amount of the information received or transmitted to the control information transmitting server.

13. The information relay terminal according to claim 12, wherein when the transmission amount of the information received or transmitted exceeds a predetermined condition, the terminal transmits the information on the transmission amount of the information to the control information transmitting server.

14. The information relay terminal according to claim 1, wherein the terminal adds specific provision information based on the information received to the information received to retransmit.

15. The information relay terminal according to claim 1, wherein the information is provided with collection information, and the terminal substitutes compiled information with the collection information and specific provision information based on the information received for the collection information to retransmit.

16. The information relay terminal according to claim 15, wherein the provision information is the information on the transmission amount of the information received or transmitted.

17. An information distribution server comprising:
an information manager that stores information substance;
a control information manager that stores control information indicating that a reward point is provided for an information relay terminal receiving and retransmitting the information;
an information generator that generates information to transmit from the information substance and the control information; and
an information transmitter that transmits the information generated to the information relay terminal.

18. The information distribution server according to claim 17, wherein the control information is provided with information indicating a method of providing the reward point for an information relay terminal receiving and retransmitting the information.

19. The information distribution server according to claim 18, wherein a value of the reward point provided to the information relay terminal differs with a kind of information relay terminal as a transmission destination or a kind of transmission path on which the information is received and transmitted.

20. The information distribution server according to claim 17, wherein the information substance is a command for instructing the information relay terminal to provide specific information.

21. An information compiling server comprising:
an information receiver that receives information provided with relay history information describing an information relay terminal that has relayed the information received;
an information interpreter that adds a reward point for the information relay terminal described in the relay history information added to the information received; and
a personal information storage that compiles and manages the reward point.

22. The information compiling server according to claim 21, wherein a value of the reward point provided to the information relay terminal differs with a kind of information relay terminal as a transmission destination or a kind of transmission path on which the information is received and transmitted.

23. A control information transmitting server comprising:
a control information manager that stores control information to retransmit received information for information relay for retransmitting the received information; and
a control information manager that stores control information for an information relay terminal that retransmits received information to retransmit the received information;
a control information transmitter that transmits the control information to an information relay terminal.

24. The control information transmitting server according to claim 23, wherein the control information includes either a relay waiting time to elapse between receiving and retransmitting the information, moving distance or the number of moving steps, or the number of relay times indicative of the limitation number of times the same information is retransmitted.

25. The control information transmitting server according to claim 23, wherein the control information includes server transfer control information for the information relay terminal to transmit the received information to an information compiling server that compiles the information.

26. The control information transmitting server according to claim 25, wherein the server transfer control information includes either the number of relay times the information has been relayed, the number of information relay terminals that have relayed the information, a relay expiration date until which the relay is available, or a server transfer expiration date until which the information is capable of being transferred to the server.

27. The control information transmitting server according to claim 23, wherein the server receives information on a transmission amount from the information relay terminal, and based on the information on the transmission amount received, changes the control information to transmit to an information relay terminal.

28. A method of relaying information, comprising:
receiving information transmitted from an information distribution server that distributes the information or another information relay terminal;
retransmitting the information received; and
adding a reward point for receiving and retransmitting the information, and managing compilation of the reward point.

29. A method of distributing information, comprising:
storing information substance;
storing control information indicating that a reward point is provided for an information relay terminal receiving and retransmitting the information;
generating information to transmit from the information substance and the control information; and
transmitting the information generated to the information relay terminal.

30. A method of compiling information, comprising:
receiving information provided with relay history information describing an information relay terminal that has relayed the information received;
adding a reward point for the information relay terminal described in the relay history information added to the information received; and
compiling and managing the reward point.

31. A method of transmitting control information, comprising:
storing control information to retransmit received information for information relay for retransmitting the received information; and
transmitting the control information to an information relay terminal.
